(19) United States
(12) Patent Application Publication
(10) Pub. No.: US 2008/0224979 A1
(43) Pub. Date: Sep. 18, 2008

(54) METHOD FOR IMPROVING IMAGE QUALITY OF A DISPLAY DEVICE WITH LOW-TEMPERATURE POLY-SILICON THIN FILM TRANSISTOR

(75) Inventors: Yu-Lin LEE, Taipei (TW); Chang-Cheng LIN, Taipei (TW); Ming-Jiun LIAW, Hsinchu (TW); Jan-Ruei LIN, Taipei (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, HSINCHU (TW)

(21) Appl. No.: 12/051,120

(22) Filed: Mar. 19, 2008

Related U.S. Application Data
(63) Continuation-in-part of application No. 10/923,689, filed on Aug. 24, 2004, now abandoned.

(30) Foreign Application Priority Data
Apr. 6, 2004 (TW) 093109418

(51) Int. Cl. G09G 3/36

(52) U.S. Cl. 345/92

(57) ABSTRACT

The Low-Temperature Poly-Silicon thin film transistor display device of the invention arrayed with a plurality of gate lines and data lines and a switch unit and a pixel unit are located in the intersection of scan line and the data line. The device comprises a gate driven unit a data driven unit and a control unit wherein the gate driven unit provides a plurality of gate voltages to the gate lines to drive the switch unit, the data driven unit sends the corresponding video data to the gate lines, and the control unit controls the transmitting sequence of the video data to the data lines. The method of the invention includes the steps of: gate driven unit providing every N scanning signals to the scan lines and then the data driven unit switching the transmitting sequence of the video data.

### RELATED APPLICATIONS

The present application is a continuation-in-part of the U.S. patent application Ser. No. 10/923,689 filed on Aug. 24, 2004, which claims the foreign priority of Taiwan patent application 093109418 filed on Apr. 4, 2004.

### FIELD OF THE INVENTION

The present inventions relate to a method for improving the image characteristics of a display device with Low-Temperature Poly-Silicon (LTPS) thin film transistor (TFT). All embodiments are implemented with LTPS TFT. The present invention provides the LTPS TFT display device a more consistent image quality and uniformity of the light illumination.

### BACKGROUND OF THE INVENTION

Because the process yield of Liquid Crystal Display (LCD) is increased recently and the advantages of light, thinness, low power consumption and low radiation of LCD, LCDs have replaced conventional CRT displays to be the most popular plane displays currently in use. The action principle of LCD structure is two panels with a plurality of electrodes to produce electric field, a liquid crystal layer between the two panels and two polarized panels attached to each panels. The illumination of outputting light is controlled by the reconditioning of liquid crystal molecules from the voltage inputting to the electrode and a plurality of thin film transistor switch are formed on the LCD panel for inputting voltage to the electrodes. A conventional active matrix color LCD is shown in FIG. 1. A plurality of gate lines 21 and data lines 11 are arrayed of the LCD. A pixel unit 13 and a switch unit 12 are located in the intersection of each gate line 21 and each data line 11. The switch unit 12 is a thin film transistor (hereafter TFT 12) of which the data line 21 is connected to the gate and the data line 11 is connected to the drain. The LCD includes a gate driven unit 20 and a data driven unit 10. The data driven unit 10 is connected to a plurality of data lines 11 for transmitting a plurality of video data to corresponding pixel unit 13 while the gate driven unit 20 is connected to a plurality of gate lines 21 for transmitting a plurality of gate voltages to gate lines 21 in sequence to turn on the gate of TFT 12 so that the data driven unit 10 can transmit the video data to the corresponding pixel unit 13.

Because resolution of LCD is increasing, the amount of data lines 11 of the data driven unit 10 has been increasing. Taking the resolution of SXGA (1280×1024) for example, the amount of data lines 11 will be 3480(1024×3). For reducing the connecting amount of data driven unit 10, method of time-sharing driving is taken to reduce the amount of data lines 10. FIG. 2 is a timing table for illustrating the action of time-sharing driving of the conventional LCD in FIG. 1. For displaying a frame by the LCD, the gate driven unit 20 inputs a gate voltage Scan (with a first period T) to drive the gate of TFT 12 so that all the TFT 12 of the gate lines 21 receiving the gate voltages drives and the data driven unit 10 transmits a plurality of video data to the corresponding pixel unit 13 in sequence in the first period T. A frame is finished when all from G1 to Gn are driven by the gate driven unit 20. For example, gate voltage Scan is transmitted to G1 by the gate driven unit 10 and then all TFT 12 of G1 are driven in the first period T in which the data driven unit 10 has to transmit the video data to the data lines and the corresponding pixel unit 13 connecting to the data lines 11. Also, in the first period T, each data line 11 having a second period T1 in which each data line 11 has to transmit video data to the corresponding pixel unit 13, such as SD1 transmitting the corresponding video data to the first pixel unit in high potential, SD2 transmitting the corresponding video data to the second pixel unit in high potential, . . . SDn transmitting the corresponding video data to the Nth pixel unit in high potential and so on. That the gate driven unit driving from G1 to Gn and video data being transmitting to the corresponding pixel unit 13 is supposed to display the predetermined frame but this kind of time-sharing driving method could be a serious problem. For example, when all the video data are gray level signals with the same video potential, each pixel unit 13 is supposed to be charged to the same potential; however, each pixel unit can be charged to the video potential only in a second period T1 due to the time-sharing driving. When G1 is driven, the data driven unit 10 turns D1 on to the video data to charge the corresponding pixel unit 13 in a second period T1. When the second period T1 passed by, D1 is turned off and D2 is turned on being transmitted to video data but TFT 12 connecting to D1 is still turned on so that the pixel unit 13 still can be charged sharing by data line D1 until the gate of TFT 12 is stopped being driven. Thus, the charging time of each pixel unit of the gate line 21 will be different so that the charging time of the first turn on pixel unit is longer than that of the second one, and so on. Because the charging time of the Nth pixel unit of the gate line 21 will be much shorter than that of the first one, the different gray level results are being shown in FIG. 3. The kind of phenomenon will be more obvious when a plurality of gray level frames is displayed continuously. Another kind of conventional LCD is a bank active matrix color LCD shown in FIG. 7 of which a plurality of gate lines 21 and a plurality of data lines 11 are arrayed. A pixel unit 13 and a switch unit (TFT) 12 are located in the intersection of each gate line 21 and each data line 11. The LCD comprises a gate driven unit 20 and a data driven unit 10a that has K data drivers 101 (K is a natural number) each one of which connects to J data lines 11 (from D1 to Dj). The first data line is the first one of J data lines while the J data line is the Jth one of that. When a frame is to be shown, the gate driven unit 20 transmits a gate voltage to the gate lines 21 in sequence. When each gate line 21 is driven, TFT 12 of that gate line 21 is turned on and then K gate drivers 101 transmit the corresponding video data to corresponding pixel unit with a sequence from the first data line to the Jth data line to form a frame. The intersection of each area will show the obvious difference (as shown in FIG. 8) if a plurality of gray level frames of the LCD are displayed.

To meet the above-mentioned problems, the present invention provides method for uniformizing frame of display device and display device of the same to solve the problems.

### SUMMARY OF THE INVENTION

It is therefore an object of this present invention to provide a method for uniformizing frames of a LTPS TFT display device.

To achieve the mentioned goal, the present invention provides a method for uniformizing frames of a LTPS FTF display device. The arrayed display device has N scan lines, M data lines, a switch unit and a pixel unit located in the intersection of the scan line and data line, a gate driven unit for providing signal to the scan lines and a data driven unit for sending corresponding video data to the data lines in sequence, the method including the steps of:

The gate driven unit providing every N scanning signals to the scan lines; and then the data driven unit switching transmitting sequence of the video data.

The invention also provides a device for uniformizing frame of a display device. The arrayed display device comprises a plurality of N gate lines, M data lines, and a switch unit and a pixel unit located in the intersection of the gate line and data line. The display device comprises a gate driven unit, a data driven unit and a control unit. The gate driven unit connects to gate lines for providing a plurality of gate voltages to the gate lines in sequence to drive the switch unit. The data driven unit connects to the data lines for sending corresponding video data to the data lines when the switch unit is driven. The control unit connects to the data driven unit for controlling sequence of sending video data to the data lines.

The above and other objects and the advantages and features of the present inventions will be more apparent from the detailed description of preferred embodiments, taken in conjunction with the drawings.

### BRIEF DESCRIPTION OF THE DRAWINGS

FIG. 1A is a schematic view of the conventional LCD.

FIG. 2 is a timing table for illustrating the action of LCD in FIG. 1.

FIGS. 3A and 3B are schematic views of a conventional LCD displaying a plurality of gray level frames continuously.

FIG. 4 is a schematic view of a LTPS TFT display device of the present invention in use.

FIG. 5 is a timing view for illustrating the action of LTPS TFT display device in FIG. 4.

FIG. 6 is a schematic view of the display device displaying a plurality of gray level frames continuously of the present invention in use.

FIG. 7 is a schematic view of another conventional LCD.

FIG. 8 is a schematic view of the conventional LCD displaying a plurality of gray level frames continuously in FIG. 7.

FIG. 9 is a schematic view of the LCD in FIG. 7 displaying a plurality of gray level frames continuously of the embodiment of the present invention in use.

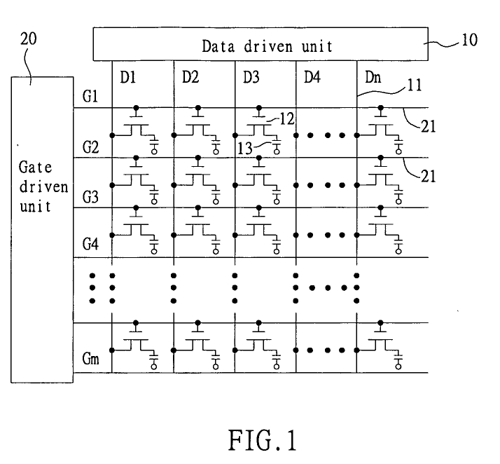

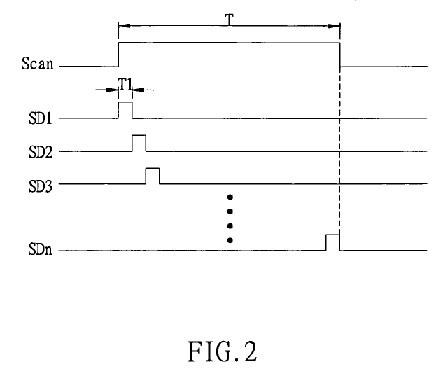

### DESCRIPTION OF THE PREFERRED EMBODIMENT

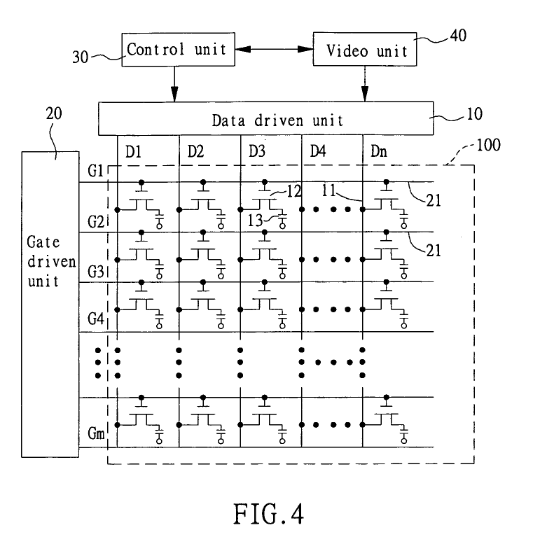

Referring to FIG. 4, a schematic view of a display device of the present invention in use is shown. The display device is active matrix color liquid crystal display (hereafter LCD) with Low-Temperature Poly-Silicon (LTPS) thin film transistor (TFT) for connecting to a personal computer to display the transmitting frame (a plurality of video data, in this case, continuous gray level frames) from PC. The arrayed LCD is arranged with M gate lines 21 (from G1 to Gm), N data lines 11 (from D1 to Dn), a switch unit 12 and a pixel unit 13 located in the intersection of the gate line 21 and data line 11. A display area 100 of the LCD is formed by the pixel units 13. The switch unit 12 is a LTPS TFT switch comprising a gate driven unit 20, a data driven unit 10, a control unit 30 and a video unit 40. The data line 11 of LCD connects to the drain of TFT 12 while the gate line 21 connects to the gate of TFT 12. The video data unit 40 connects to the data driven unit 10 for saving the showing frame from PC (a plurality of video data) temporarily. The data driven unit 10 connects to the video data unit 40 while the control unit 30 transmits the video data to the data driven unit 10 with a specified sequence and then transmits the corresponding pixel unit 13. A plurality of gate voltages and M gate lines 21 are provided from the gate driven unit 20 for driving the gate of TFT 12 of the gate lines 21 to transmit the video data to the corresponding pixel unit 13. The control unit 30 connecting to the data driven unit 10 controls the transmitting sequence of N data lines 11 sent from video data. For showing a frame of LCD, when the gate driven unit 20 inputs a gate voltage to each gate line 21 and each gate line 21 is driven, the data driven unit 10 transmits a plurality of video data to pixel unit 13 corresponding to the driven data lines 21. The gate driven unit 20 drives the gate lines 21 (from G1 to Gm) in sequence in a period and after that a complete frame of the LCD is shown. Repeating driving M gate lines 21 (from G1 to Gm), I frames can be displayed continuously from the LCD.

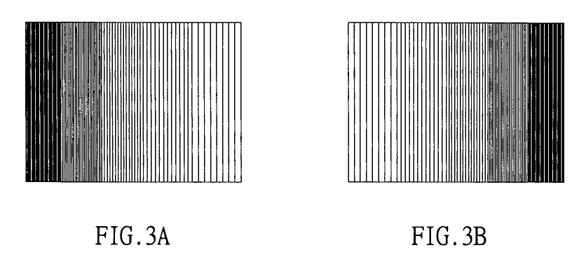

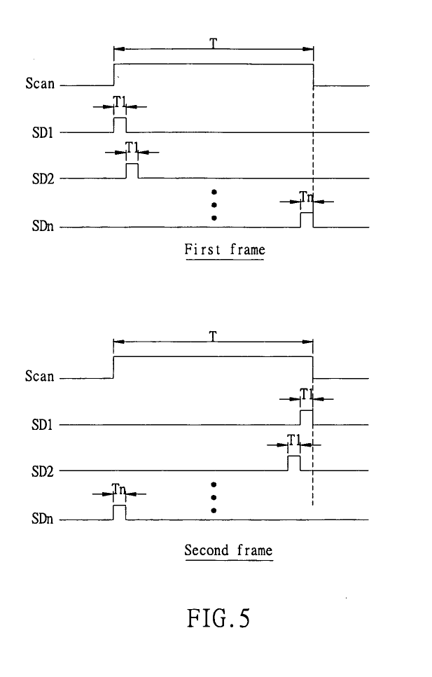

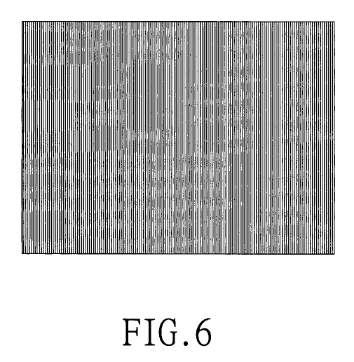

The method of this invention applied to LCD in FIG. 4 is illustrated in a timing table shown in FIG. 5. When the first frame is displayed in a LCD, the gate driven unit 20 inputs a gate voltage “Scan” having a period “T” first. After G1 receives the gate voltage, TFT 12 connecting to the G1 is driven since when the data driven unit 10 transmits the video data to the corresponding pixel unit 13 in the first period T with a transmitting sequence from D1 to Dn. For example, the data driven unit 10 turns on D1 afterward which transmits video data to the corresponding pixel unit in SD1 high potential; the data driven unit 10 turns on D2 which transmits video data to the corresponding pixel unit in SD2 high potential and so on. Thus, the data driven unit 10 turns on Dn afterward which transmits video data to the corresponding pixel unit in SDn high potential and in the same period, only one data line 11 of the same gate line 21 is turned on for transmitting video data. After the first period T, the gate driven unit 20 keeps driving G2 to the corresponding pixel unit 13 with a sequence from D1 to Dn. By following the same way, Gn is driven by the gate driven unit to form the first frame shown in FIG. 3a. When the second frame is displayed in a LCD, the gate driven unit 20 keeps the driving sequence from G1 to Gm to drive M gate lines. However, whenever a gate line is driven, the control unit 30 controls the transmitting sequence of data driven unit 10 for transmitting the video data to the corresponding pixel unit 30 to form the second frame as shown in FIG. 3b. When the third frame is displayed in a LCD, the gate driven unit 20 drives M gate lines 21 (from G1 to Gm) in sequence. Whenever a gate line 21 is driven, the control unit switches the transmitting sequence from D1 to Dn (as the transmitting sequence of the first frame) of the data driven unit 10 for transmitting video data to the corresponding pixel unit 13. Until Gn is driven by the gate driven unit 20, the third frame is finished as shown in FIG. 3a. For displaying the next frame, the control unit switches the transmitting sequence of data driven unit 10 again and then a plurality of frames is displayed by the way of showing a frame with a switch of transmitting sequence of video data. When a plurality of gray level frames is displayed, the frames are uniformed (as shown in FIG. 6) through the principle of persistence of vision in order to solve the problem of showing different gray level results by sending the same frame of the conventional LCD. The active matrix color LCD here is for illustrating but cannot limit the application scope of the method of the invention which can be used in other LCDs known by the people skilled in the art.

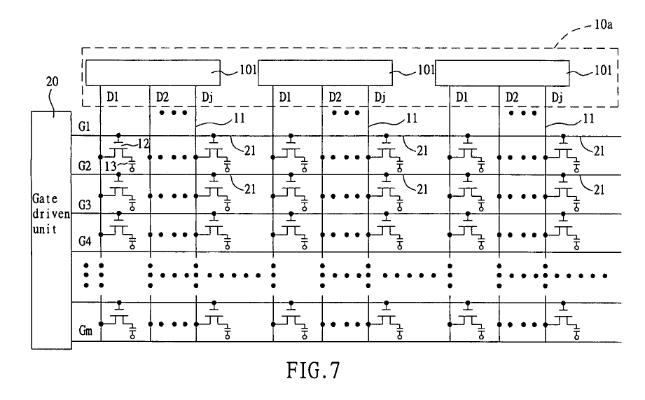

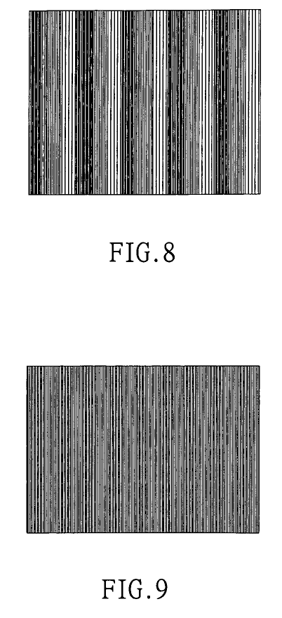

The other embodiment of the invention is applied to the LCD shown in FIG. 7. The LCD is a bank active matrix color LCD arrayed with a plurality of gate lines 21 and data lines 11. A switch unit 12 (TFT 12) and a pixel unit 13 located in the intersection of each gate line 21 and each data line 11. The display device comprises a gate driven unit 20 and a data driven unit 10a. The data driven unit 10a has K data drivers 101 (K is a natural number) each one of which connects to J data lines 11 (from D1 to Dj). The first data line is the first one of J data lines while the J data line is the Jₜₕ one of that. When a frame is to be shown, the gate driven unit 20 transmits a gate voltage to the gate lines 21 in sequence. When each gate line 21 is driven, TFT 12 of that gate line 21 is turned on and then K gate drivers 101 transmit the corresponding video data to corresponding pixel unit with a sequence from the first data line to the Jₜₕ data line; for displaying the second frame, the K data drivers 101 switches the transmitting sequence for transmitting corresponding video data to the corresponding pixel unit 13 from the Jₜₕ data line to the first data line in sequence at the same time. By following the same reason, whenever as frame is finished, the K data drivers switches the transmitting sequence of video signals. When a plurality of gray level frames is displayed, the frames are uniformed (as shown in FIG. 9) through the principle of persistence of vision.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method for uniformizing frames of a Low-Temperature Poly-Silicon (LTPS) thin film transistor (TFT) display device, comprising:
said LTPS TFT display device comprising:
arrays of M scan lines and N data lines,
a switch unit and a pixel unit located in the intersection of said scan line and said data line,
a gate driven unit for providing signal to said scan lines;
a data driven unit for sending corresponding video data to said data lines in sequence, and;
said gate driven unit providing every M scanning signals to said scan lines; and then said data driven unit switching transmitting sequence of said video data.

2. The method of claim 1, wherein said LTPS TFT display device is an active matrix liquid crystal display and said switch unit is a LTPS TFT.

3. The method of claim 1, wherein said data driven unit having K data drivers connecting to D data lines from the first data line to the Dₜₕ data line of the D data lines, said K data drivers send corresponding video data with a sequence from the first data line to the Dₜₕ data line at the same time, after said gate driven unit provides said M scan signals to said scan lines, said K data drivers switch sequence from the Dₜₕ data line to the first data line of the D data lines for sending corresponding video data, and whenever after said gate driven unit provides every M scan signals to said scan lines, said K data drivers change the transmitting sequence of said video data.

4. A method for uniformizing frames of a LTPS TFT display device, said display device arranging M gate lines and N data lines from D1 to Dn in array, a switch unit and a pixel unit located in the intersection of said gate line and said data line, said display device having a gate driven unit for providing a plurality of gate voltages to said data line in sequence to drive said switch unit in a period and a data driven unit for providing corresponding video data to said pixel unit to drive said display device whenever said switch unit is driven, wherein finishing a period is defined as a frame, said display device being configured for displaying I frames continuously, said method comprising the steps of:
said driven unit providing video data to said data lines with a sequence from D1 to Dn on the first frame;
said driven unit providing video data to said data lines with a sequence from Dn to D1 on the second frame;
said driven unit providing video data to said data lines with a sequence from D1 to Dn on the third frame, and
repeating said steps for displaying said I frames.

5. The method of claim 4, wherein said data driven unit has K data drivers connecting to J data lines from the first data line to the Jth data line of the J data lines,
said K data drivers transmitting corresponding video data to said data lines with a sequence from J1 data line to Jn data line on the first frame;
said K data drivers switching the transmitting sequence for transmitting corresponding video data from Jn data line to J1 data line to said data lines on the second frame, and
said K data drivers switching the transmitting sequence after every frame being finished.

6. The method of claim 4, wherein said display device is an active matrix liquid crystal display and said switch unit is made of a thin film transistor.

7. A LTPS TFT display device for uniformizing frames, said display device arrayed with a plurality of gate lines and data lines, a switch unit and a pixel unit located in the intersection of said gate line and said data line, said device comprising:
a gate driven unit connecting to said gate lines for providing a plurality of gate voltages to said gate lines in sequence to drive said switch unit;
a data driven unit connecting to said data lines for sending corresponding video data to said data lines when said switch unit is driven, and
a control unit connecting to said data driven unit for controlling sequence of sending said video data to said data lines.

8. The LTPS TFT display device of claim 7, wherein said device further comprises a video data unit connecting to said data driven unit for saving video data temporarily and for receiving video data with sequence according to said control unit.

9. The LTPS TFT display device of claim 7, wherein said data driven unit has K data drivers connecting to each said data line with arrangement of parallel connection.

10. The LTPS TFT display device of claim 7, wherein said LTPS TFT display device is an active matrix liquid crystal display and said switch unit is a thin film transistor.
